(19) United States
(12) Patent Application Publication
(10) Pub. No.: US 2006/0033035 A1
(43) Pub. Date: Feb. 16, 2006

(54) Electron microscope array for inspection and lithography

(76) Inventors: Mordechai Itzkovitch, Petach Tikva (IL); Vladimir Kolarik, Brno (CZ); Gilad Golan, Raanana (IL); Jacob Karin, Ramat Gan (IL)

Correspondence Address: DR. MARK FRIEDMAN LTD.;C/o Bill Polkinghorn, 9003 Florin Way, Upper Marlboro, MD, 20772, US

(21) Appl. No.: 11/203,299

(22) Filed: Aug. 15, 2005

Related U.S. Application Data
(60) Provisional application No. 60/606,469, filed on Sep. 2, 2004.
(60) Provisional application No. 60/606,462, filed on Sep. 2, 2004.
(60) Provisional application No. 60/606,461, filed on Sep. 2, 2004.
(60) Provisional application No. 60/606,470, filed on Sep. 2, 2004.
(60) Provisional application No. 60/601,625, filed on Aug. 16, 2004.
(60) Provisional application No. 60/608,416, filed on Sep. 10, 2004.

(51) Int. Cl. H01J 1/50

(52) U.S. Cl. 250/396 ML

(57) ABSTRACT

A system and method for rapidly processing a specimen. The method includes generating a plurality of charged-particle beams travelling substantially along respective axes of an array of charged-particle beam columns by providing each beam column with two permanent magnets having at least one magnetic dipole disposed in a plane perpendicular to the axis. The trajectory of the beams is independently controlled and the beam is focussed onto the specimen using additional correctional coils. The beams are deflected while maintaining incidence of the beam on the specimen parallel to the axis. Preferably, the charged particle beams include non-crossover charged particle beams. Preferably, the method further includes detecting charged particles scattered from the specimen using a detector at least partially immersed in a magnetic field, by utilizing at least in part the magnetic field.

### CROSS REFERENCE TO RELATED APPLICATIONS

This application claims the benefit from US provisional applications: 60/606,469, 60/606,462, 60/606,461, and 60/606,470 filed on 2-Sep. 2004; and 60/601,625 filed on filed on 16-Aug. 2004, and 60/608,416 filed on 10-Sep. 2004, by the present inventors.

### FIELD AND BACKGROUND OF THE INVENTION

The present invention relates to inspection, review and lithography of wafers for integrated circuit manufacturing.

Electron beams are used routinely during processing of silicon wafers for integrated circuit manufacturing. Electron beam lithography is often used to create features in lithographic masks and wafers. Inspection of semiconductor devices fabricated in silicon wafers is routinely performed using a scanning electron beam microscopy. Once a defect is located, scanning electron beam review systems are used with high resolution to carefully probe, analyze and classify the nature of the defect. Unlike optical microscopy, which has a limited resolution due to optical diffraction, electron beams are capable of resolving structures of dimension much less than 100 mm., as required for modern semiconductor manufacturing processes.

Commercially available electron beam-based inspection machines use a single electron beam column. The single primary electron beam is raster scanned on a processed semiconductor wafer. The scattered electrons can be divided into two groups according to their interaction with the specimen. An elastic interaction result in scattered electrons with energy close to the incident electron these electrons are called back scattered Electrons (BSE). Inelastic interaction of electrons with the material cause low energy electrons in the range of 2 eV to 50 eV to be emitted from the specimen. These electrons are called Secondary Electrons (SE). Secondary and/or back-scattered electrons generated by the primary beam are detected and registered pixel-by-pixel using conventional image processing techniques to reconstruct an image of the inspected region. Low throughput is a significant drawback in such machines, because the images are acquired as described above pixel-by-pixel in a sequential manner. In prior art machines, the throughput cannot be significantly improved by increasing the rate of scanning. Increasing the scanning rate and maintaining the same SNR (signal to noise ratio) of the acquired image requires a simultaneous increase in beam current, in order to maintain contrast. Since electrons in a scanning electron microscope are charged particles an increase in current is associated with higher electron to electron interaction which cause Coulomb aberrations a main limitation to the resolution of the microscope at high current. Coulomb aberrations increase significantly in the high density of electrons in the vicinity of crossover points.

The detectors of the BSE are usually mounted at the lower end of the column concentric to the primary electron beam. In some cases, typically when the signal is below the thermal noise of the electronic analogue front end there is a need to incorporate an electron multiplier for the current amplification of electrons by applying a multiplication process. The multiplication is accomplished either by multichannel plate (MCP) or by discrete dynodes. If a high current density is required, a MCP detector is not practical and a discrete dynodes detector is an option. A discrete dynodes detector uses a series of surfaces on which a secondary electron multiplication process occurs. High voltage applied to the dynodes generates an electric field which accelerates the electrons created at each stage to the next stage up toward the collecting anode. There are several well known discrete dynode configurations, which are not applicable in the presence of high magnetic field especially in the orientation parallel to the axis. In the presence of magnetic field, the trajectories of charged particles are strongly curved and the multiplication factor of the detector drops strongly. In a detector including discrete dynodes, this curve in the particle trajectories may cause electrons not to reach the next stage. Therefore conventional dynode configurations fail or reduce multiplication in the presence of strong magnetic field.

An increase in throughput in electron beam inspection and lithography systems has been disclosed by simultaneously using arrays of electron beams or electron beam columns. Lo et al., in US patent publication U.S. Pat. No. 6,750,455, disclose an array of electron beam columns, the columns all sharing a single objective lens and each column with its own objective pole piece. US patent publication U.S. Pat. No. 6,750,455 is characterized by a lens generated by a large coil around the column array. The field throughout the array is not uniform. Furthermore, array assemblies of different number of columns require design modifications since each additional column affects the overall field.

In US patent publication U.S. Pat. No. 6,844,550 is disclosed a design for an array of electron beam columns using only electrostatic elements, with no magnetic elements.

There is thus a need for, and it would be highly advantageous to have a system including of an array of miniature electron beam columns in a compact design, characterized by low aberration and low power consumption for attaining a high processing throughput. It would be further advantageous to have a detector capable of detecting high currents of scattered electrons from the specimen even in the presence of a strong magnetic field.

### SUMMARY OF THE INVENTION

The term “processing” as used herein refers to inspection, review and lithography such as of a semiconductor wafer. The term “specimen” as used herein refers to a sample under inspection and/or lithography. The term “charged particle” as used herein refers to, but is not limited, to electrons, and/or ions. The term “scattered” as in “scattered” electron from a primary electron incident on a specimen, includes both secondary electrons and back-scattered electrons and therefore includes all electrons emitted from the specimen independent of energy and whether the process is elastic or inelastic. The term “axis” of a charged particle beam column is typically the axis of at least partial rotational and/or cylindrical symmetry of the electromagnetic field, parallel to direction of flow of charged particles within the column. The term “downstream” refers to the direction of flow of charged particles along the axis of the column.

According to the present invention there is provided a beam column including a beam of charged particles which travels substantially along an axis of the column. The beam column includes two permanent magnets each having a magnetic dipole disposed in a plane perpendicular to the axis. Magnetic material is located within the magnetic field of the permanent magnets and the magnetic material is configured or shaped to increase cylindrical symmetry of the field. The permanent magnets influence trajectories of the charge particles within the column. The column further includes a correction coil in proximity to an end of one of the permanent magnets. Preferably, the permanent magnets are configured to generate a non-crossover primary charged-particle beam within the column. Preferably, the column, further includes a charged particle source and specimen immersed in part by the magnetic field of the permanent magnets. Preferably, the column further includes a detector which detects charged particles scattered from the specimen, the detector including electrodes configured with potential difference between the electrodes. The electrodes include a material which exhibits emission of secondary electrons and the detector is immersed at least in part by the magnetic field of the permanent magnets, and a parameter of the detector is adjusted for maximizing signal multiplication of the electrons, by utilizing at least in part said magnetic field. Preferably, the permanent magnets operate as a gun lens, wherein a focal length of said gun lens is changed by independently adjusting current in said correction coil and the permanent magnets operate as an objective lens, wherein a focal length of said objective lens is changed by independently adjusting current in said correction coil. Preferably, the column includes multi-pole charged particle beam deflecting elements which form two or more stages of a multi-pole charged particle beam deflecting assembly and the charged particle beam is deflected serially by the two or more stages, so that the charged particle beam is incident on a specimen in a direction parallel to the axis. Preferably, the column, further includes a detector which detects electrons scattered from said specimen, the detector including electrodes configured with potential differences between the electrodes, and the electrodes include a material which exhibits emission of secondary electrons. The detector is immersed at least in part by a magnetic field and a parameter of the detector is adjusted for maximizing signal multiplication of the electrons by utilizing the magnetic field.

According to the present invention there is provided a system comprising at least one column having an axis. The column includes at least one source of charged particles which form a charged particle beam which moves through the a column in a direction substantially parallel to the axis; and multi-pole charged particle beam deflecting elements which form at least two stages of a multi-pole charged particle beam deflecting assembly. The charged particle beam is deflected serially by the two or more stages, so that the charged particle beam is incident on a specimen in a direction substantially parallel to the axis. Preferably, there are four of the deflecting elements in each stage. Preferably, the charged particle beam is deflected by an electric field produced by placing a potential difference between the elements. Preferably, the column further includes two or more permanent magnets having at least one magnetic dipole disposed in a plane perpendicular to the axis. Preferably, the column further includes a correction coil in proximity to an end of one of said permanent magnets. Preferably, the system includes multiple columns, and two or more columns are parallel so that all charged particle beams impinge substantially at normal incidence on a specimen or the columns are substantially tilted with respect to each other so that respective charged particle beams from the columns impinge on an overlapping region of a specimen at different incident angles. Preferably, one column includes a column with axis normal to a specimen and another column is substantially tilted relative to the specimen. Preferably, the system includes one column with higher resolution, a moveable column, and/or a column equipped with energy dispersion X ray analysis. Preferably, the magnets are configured for generating a non-crossover charged-particle beam. Preferably, the column further includes a detector which detects electrons scattered from the specimen, the detector including electrodes configured with potential differences between the electrodes, and the electrodes include a material which exhibits emission of secondary electrons, and the detector is immersed at least in part by a magnetic field wherein a parameter of the detector is adjusted for maximizing signal multiplication of the electrons by utilizing the magnetic field.

According to the present invention there is provided a detector in a charged-particle-optical system, wherein the system generates and deflects a charged-particle beam. The detector detects charged particles scattered from a specimen, the detector includes electrodes configured with potential differences between the electrodes. The electrodes include a material which exhibits secondary electron emission which provides signal multiplication. The detector is immersed at least in part by a magnetic field, wherein a parameter of the detector is adjusted for maximizing detection performance of the electrons, thereby utilizing at least in part said magnetic field, and the system generates a primary charged-particle beam substantially normally incident on the specimen. Preferably, the detector includes layers, including conducting layers interspersed insulating layers, each layer having an array of holes therein, the holes are aligned. The holes within the conducting layers are coated with the material exhibiting secondary emission, and the electrodes are the conducting layers. Preferably, the adjustable parameter is the material having secondary emission, one or more of the potential differences, a layer thickness, and/or a hole diameter. Preferably, the electrodes includes parallel grids, and each grid includes conducting wires. The grids are coated with the material having secondary emission. A spacer separates the grids; and a voltage supply is configured to maintain the potential difference between the grids. Preferably, when the detector is made from grids, the adjustable parameter is the material having secondary emission, one or more potential differences between grids, thickness of a wire, a distance between wires, and distance between the planes.

According to the present invention there is provided a method for rapidly processing a specimen. The method includes generating a plurality of charged-particle beams travelling substantially along respective axes of an array of charged-particle beam columns by providing each beam column with two permanent magnets having at least one magnetic dipole disposed in a plane perpendicular to the axis; and independently controlling trajectory and focussing the beams onto the specimen. The beams are deflected while maintaining incidence of the beam on the specimen parallel to the axis. Preferably, the deflecting includes scanning by one charged particle beam, not performed simultaneously with scanning by another of the charged particle beams. Preferably, the charged particle beams include non-crossover charged particle beams. Preferably, the method further includes detecting charged particles scattered from the specimen using a detector at least partially immersed in a magnetic field, by utilizing at least in part the magnetic field. Preferably, the detector includes a plurality of electrodes configured with potential differences between the electrodes, and the electrodes include a material which exhibits secondary electron emission which provides signal multiplication. A parameter of the detector is adjusted for maximizing detection performance. Preferably, in each column a correction coil is located at an end of the permanent magnets; and the beam is controlled and focussed by adjusting current in the correction coil. Preferably, the deflecting is performed in each column using a plurality of multi-pole charged particle beam deflecting elements which form a multi-stage multi-pole charged particle beam deflecting assembly.

According to the present invention there is provided a method for detecting charged particles. The method includes providing a plurality of electrodes wherein the electrodes include a material which exhibits emission of secondary electrons; and immersing the electrodes at least in part by a magnetic field. The detection of electrons is maximized so that at least one trajectory of said secondary electrons impinge on the electrodes by utilizing the magnetic field. Preferably, the method includes generating a charged-particle beam travelling substantially along an axis of a charged-particle beam column, by providing the beam column with permanent magnets having a magnetic dipole disposed in a plane perpendicular to the axis; and the magnetic field is provided at least in part by the magnets.

### BRIEF DESCRIPTION OF THE DRAWINGS

The invention is herein described, by way of example only, with reference to the accompanying drawings, wherein:

FIG. 1 is an axial sectional view of a miniature electron-beam column that is constructed and operable in accordance with a preferred embodiment of the invention;

FIG. 2 is an isometric view of the miniature column of FIG. 1.

FIG. 3 is an isometric view of a miniature electron-beam column of FIG. 1 as inserted into a system housing;

FIG. 4 is a diagram illustrating the non-cross over operation of the column of FIG. 1;

FIG. 5 is a schematic view showing an octupole for use with the column of FIG. 1.

FIG. 6 is a sectional view of a system including multiple miniature electron-beam columns that is constructed and operable in accordance with a preferred embodiment of the invention;

FIG. 7 is a sectional view of a system including multiple miniature electron-beam columns that is constructed and operable in accordance with another preferred embodiment of the invention;

FIG. 8 is an schematic view of a first embodiment of a detector, for use with an electron beam column system, according to an embodiment of the present invention;

FIG. 9 is an isometric view showing electron trajectories in the detector of FIG. 8; and

FIG. 10 is a sectional view of a second embodiment of a detector, for use with an electron beam column system, according to another embodiment of the present invention.

### DESCRIPTION OF THE PREFERRED EMBODIMENTS

The present invention is of a system and method for processing, e.g. inspection, review and/or lithography of semiconductor wafers. Specifically, the system includes an array of electron beam columns. In each column, a magnetic field is generated using permanent magnets to provide a primary electron beam in each column. In order to achieve high current densities without aberration, a non-crossover design is preferred. Furthermore, a detector is required which is both suitable for high current densities and is capable of significant multiplication even in the presence of the high magnetic field of the permanent magnets of the column.

The principles and operation of a system and method of for processing semiconductor wafers, according to the present invention, may be better understood with reference to the drawings and the accompanying description.

It should be noted, that although the discussion herein relates to primarily to inspection of semiconductor wafers, the present invention may, by non-limiting example, alternatively be configured as well for lithography of semiconductor wafers or review of semiconductor wafers.

In some embodiments of the present invention, e.g. for lithography, a detector is not necessary, however the detector is useful, for instance, for closed loop control of the lithography process. Further more, although the discussion herein relates primarily to semiconductor, e.g. Si wafers, the present invention may, by non-limiting example be applied to other substrates, particular metals and even insulators.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

By way of introduction, a principal intention of the present invention is to provide a system of multiple miniature columns, typically ˜50 mm. long and ˜35 mm in diameter, with negligible interference between the columns. Each miniature electron beam column includes the following subsystems: a electron gun subsystem which provides the primary electrons, an electron optics subsystem which controls the primary beam by magnetic and electromagnetic focusing, electrostatic scanning for deflecting the primary beam and canceling aberrations, i.e. astigmatism, a detection subsystem which detects scattered electrons from the specimen and a vacuum subsystem for providing a vacuum appropriate for each subsystem of the column.

Preferably, the vacuum subsystems are shared between the columns.

Another intention of the present invention is to incorporate an electron detector capable of detecting electrons at currents up to about 10 microampere and at sampling rate of 250 Mpixels/sec or higher. The detector, according to the present invention overcomes the prior art problems experienced by conventional discrete dynode configurations due to the force of the magnetic field. An embodiment of the present invention utilises a combination of magnetic and electric forces to multiply electrons efficiently, using a low-cost configuration that has a longer life compared to existing methods.

The present invention, different embodiments is applicable to lithography, particularly of semiconductor masks and wafers used for producing integrated circuit, and inspection of semiconductor wafers for defects during the process. When a defect is located, the present invention, in specific embodiments can be further utilized to provide sufficient information required to properly review and classify the defect as required for manufacturing yield management. In some embodiments of the present invention, the system includes multiple miniature columns each optimized for different working conditions to gather more information for accurate classification.

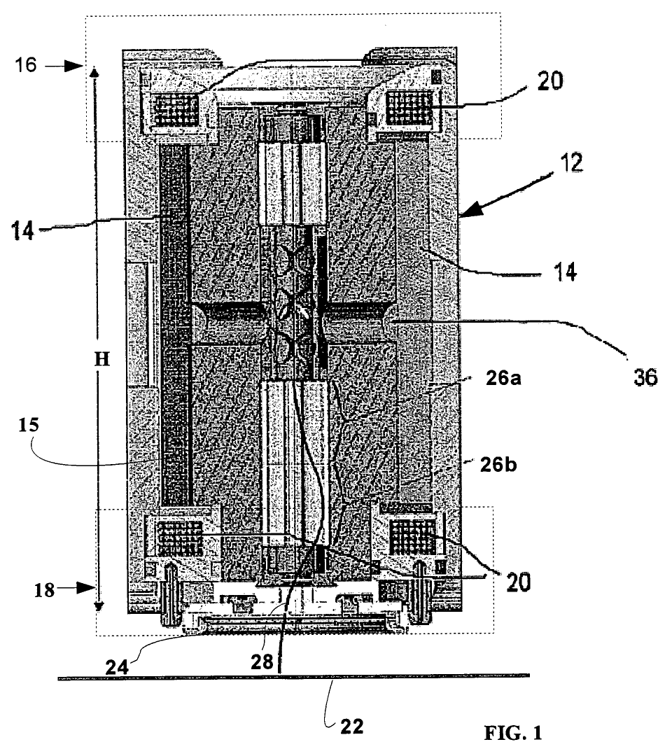

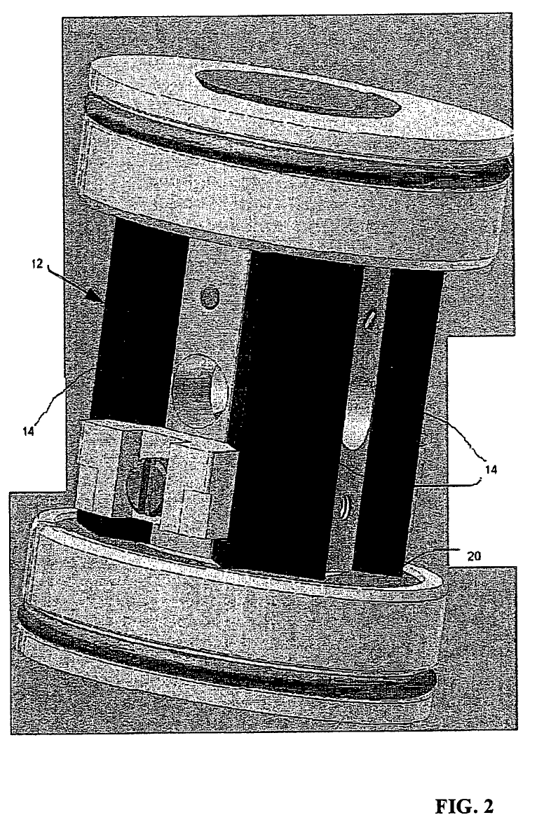

Reference is now made to FIGS. 1 and 2. FIG. 1 is an axial sectional view of a miniature electron-beam column 12 that is constructed and operable in accordance with a preferred embodiment of the invention. FIG. 2 is an isometric view of miniature electron-beam column 12. Vacuum is provided to column 12 through vacuum port 36. A gun lens 16 and an objective lens 18 are generated by a set of four permanent magnets 14. Permanent magnets 14 are bar magnets typically disposed such that, the direction of elongation of permanent magnets 14 is aligned with the axis of miniature electron-beam column 12. Permanent magnets 14 are typically equally spaced around miniature electron-beam column 12. Permanent magnets 14 are configured so that the north poles of permanent magnets 14 face toward the axis of miniature electron-beam column 12 and the south poles of permanent magnets 14 face away from the axis of miniature electron-beam column 12. However, it will be appreciated by those ordinarily skilled in the art that the south poles of permanent magnets 14 can face towards the axis and the north poles can face away from the axis. It will be appreciated by those ordinarily skilled in the art that permanent magnets 14 can be configured differently to generate the lenses. It will be appreciated by those ordinarily skilled in the art that there can be more than four or less than four permanent magnets 14. Preferably, for instance when two permanent magnets 14 are used, magnetic material 15 is located around magnets 14 in the magnetic field of magnets 14 to preferably provide a cylindrically symmetric field. Magnetic material 15 has a bore to allow electrons of the primary beam to pass through the bore.

Another embodiment of the present invention includes permanent magnets 14 arranged in a cascade, for instance with one set of two permanent magnets 14 located downstream from another set of two permanent magnets 14.

Correction coils 20 are disposed at one or both ends of miniature electron-beam column 12 or at one or both ends of the permanent magnets 14. Each correction coil 20 is preferably annular shaped. By changing current through correction coil 20, the foci of gun lens 16 and/or objective lens 18 is independently adjusted.

According to a preferred embodiment, correction coils 20 are made of a double wire. The double wire maintains a constant total current thus there is constant heating of the coil over the full operating range of the electromagnetic lens from zero power of the lens when two currents flow in opposite directions to the maximum lens power when the two currents flow in the same direction. Over this range, the magnetic field strength produced by correction coil 20 is proportional to the difference in current between the two wires. The double wire allows correction coil 20 perform magnetic field adjustments without changing the thermal characteristics of column 12 because the adjustment may be made with a constant heating effect through each correction coil 20.

According to an embodiment of the present invention column 12 includes two single-pole-piece immersion lenses 16, 18 having a symmetric configuration between the electron source (not shown) and a specimen 22. In some embodiments, the configuration of lenses 16, 18 images the source on specimen 22 with a 1:1 ratio. The resolution of miniature electron-beam column 12 depends on the degree of optical aberrations, the virtual source size and the electron-electron interaction aberrations. Miniature electron-beam column 12 typically includes an electron beam source, such as a Schottky source (not shown), generally having a virtual source size of less than 20 nm. “Optical” aberrations are minimized using immersion lens principles for lenses 16, 18 on the source and the specimen sides of miniature electron-beam column 12, respectively.

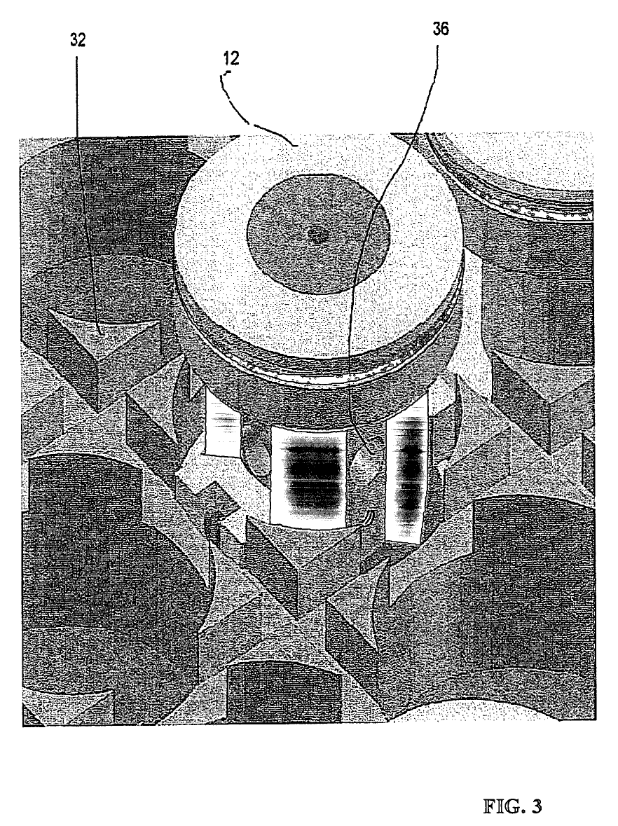

Reference is now made to FIG. 3 which illustrates in isometric view miniature electron beam column 12 inserting into a housing 32 suitable for multiple parallel columns 12.

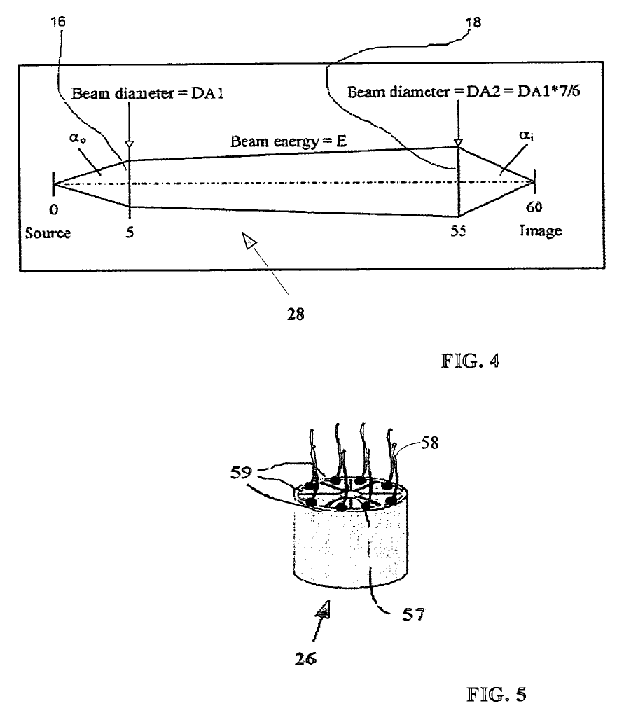

A schematic drawing illustrating the profile of electron beam 28 is shown in FIG. 4. Electron-electron aberration is minimized by two features of the design of miniature electron-beam column 12, the non-crossover electron optic design and the short column length where electrons interact with each other reducing Coulomb aberrations to maintain good resolution even when using high currents of up to 1 microampere.

Electrons emitted by specimen 22 are collected by a detector 24 near the base of miniature electron-beam column 12. Only electrons with energy above an energy threshold will generate secondary emission upon hitting the dynode and will have the probability to be detected on the detector anode. This threshold in the range of e.g. 500 eV. In this case without an accelerating field, the only electrons detected will be back-scattered electrons of energy above the threshold. In order to detect secondary electrons or lower energy, an accelerating field is required so the secondary electrons will reach the above-mentioned threshold. The scattered electrons maintain spatial separation on the detector plane thereby allowing for topological contrast mechanisms. The yield of backscattered electrons emitted from specimen 22 is nearly linearly dependent on an atomic number, a feature which provides material contrast. Voltage contrast is another feature of the scattered electrons. The electron gun (not shown) is placed in the vicinity of gun lens 16. Specimen 22 is placed in the vicinity of the objective lens 18. The total magnetic force is configured such that, a substantially parallel electron-beam is formed between the two lenses. Adjusting the current of correction coils 20 independently changes the focal lengths of the lenses. Permanent magnets 14 are configured in order to minimize power dissipation in the correction coils 20.

Therefore, miniature electron-beam column 12 fits a variety of gun and specimen 22 parameters, for example, specific landing-energy conditions or working distances between specimen 22 and column 12. Miniature electron-beam column 12 provides a compact column design, which achieves typical resolutions of between 10 t 100 nm with probe currents between 10 nanoampere to 1 microampere and landing energy between 300 eV to 5 KeV.

Referring back to FIG. 1, miniature electron-beam column 12 also includes a multi-pole electron beam deflecting element 26a and a second multi-pole electron beam deflecting element 26b. Each multi-pole electron-beam deflecting element 26 is typically an eight-pole element, known as an octupole. However, it will be appreciated by those ordinarily skilled in the art that each multi-pole electron beam deflecting element 26 can have four or more electron beam deflecting elements. Multi-pole electron beam deflecting elements 26a and 26b are preferably adjacent to each other within miniature electron-beam column 12 near objective lens 18. Multi-pole electron beam deflecting elements 26a and 26b form a double stage multi-pole electron beam deflecting element. However, it will be appreciated by those ordinarily skilled in the art that two or more multi-pole electron beam defecting elements can be stacked to form a multi-stage electron beam deflecting element. Multi-pole electron beam deflecting elements 26a and 26b are configured for deflecting electron beam 28 thereby enabling scanning of electron beam 28 across specimen 22 or correction of the position of electron beam 28. The use of single octupoles for deflecting electron beams are known. For example, an octupole is used in the LVEM5 device commercially available from Delong Instruments of Bulharka 48, Brno 61200, Czech Republic. Nevertheless, the novel combination of a double multi-pole electron beam deflecting element enables deflecting electron beam 28 while ensuring that electron beam 28 is incident on the surface of specimen 22 from a direction substantially parallel to the column axis. For instance, when the column axis is normal to specimen 22, deflected electron beam 28 is incident normally on specimen 22. This is especially useful for scanning microchips which are generally flat. FIG. 1 shows multi-pole electron beam deflecting element 26a deflecting electron beam 28 to the right and multi-pole electron beam deflecting element 26b deflecting electron beam 28 to the left. The overall deflection of electron beam 28 is to the left. It is seen that electron beam 28 is nearly normally incident on specimen 22.

Reference is now made to FIG. 5. FIG. 5 illustrates schematically the multi-pole electron beam deflecting element 26 with eight deflecting sub-elements 59 for use with column 12. A round cross-sectional axial hole 57 enables electron beam 28 to pass through. Eight electrically isolated conducting anodes 59 are formed around hole 57. Wires 58 are connected to the anodes to supply high frequency current for high frequency deflection and low frequency current is supplied for correction such as astigmatism and beam centering on the axis of symmetry.

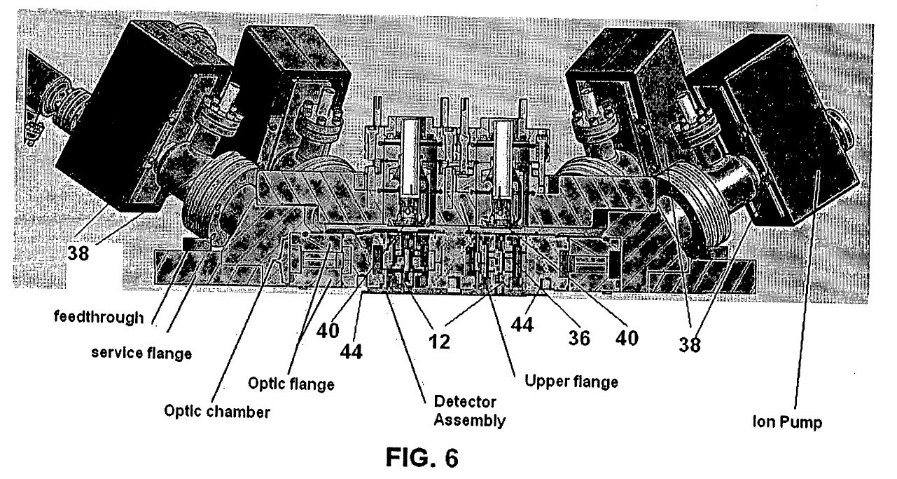

FIG. 6 is a sectional view of a multi miniature electron-beam column system 10 that is constructed and operable in accordance with a preferred embodiment of the invention. The source side is separated from the specimen side by an intermediate level of pumping at ports 36. All the miniature columns 12 have integrated vacuum pump systems 38 that pump all the gun heads in parallel. Differential pumping is performed independently at the gun head chamber 40, intermediate level at ports 36 and specimen chamber (not shown). With independent differential pumping, high vacuum is achieved as required for the guns while maintaining sufficient vacuum in the specimen 22 chamber. For in-line wafer inspection systems, the wafer under processing is not ultra-high vacuum compliant especially after lithographic steps. The electron-beam source requires ultra high vacuum in order to maintain stable emission a requirement for maintaining the life time of the electron-beam source and otherwise to insure a stable process. The magnetic field homogeneity symmetry of miniature electron-beam column system 10 is maintained even at the borders of the array. Additional layer of “dummy” columns 44 that include only fixed magnets may be used either periodically within the array of columns and/or at the perimeter of the column array to further increase the magnetic field homogeneity.

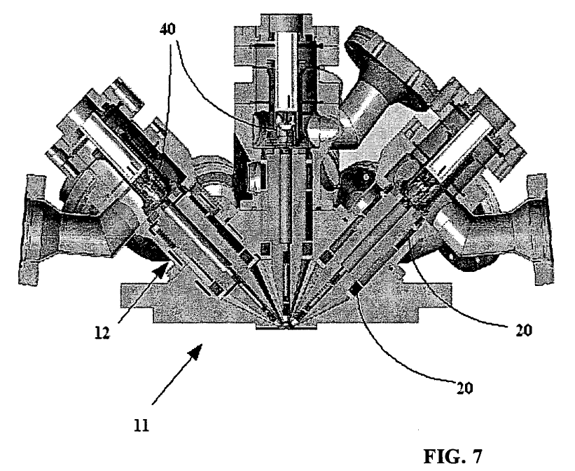

Another possible configuration 11 of the present invention is shown in FIG. 7. In configuration 11, columns 12 are not parallel but tilted to focus multiple electron beams onto a partially overlapped field of view of specimen 22. The use of tilted beam electron beams allows combining image data as viewed from different angles in addition to viewing from the top (normally) which allows for true perspective and three dimensional imaging. For wafer review, a defect is accurately classified regarding defect type, size and shape when three dimensional imaging is used by almost simultaneously imaging the single defect with multiple beams at different incident angles. Configuration 11 can include many options such as one to four tilted columns, with or without an additional top view column. The tilted column scanning mechanism is further improved by enabling dynamical changes of the focus while scanning the image to compensate for the change of the working distance between adjacent scanned lines. Preferably, scanning is not performed simultaneously. Since scanning simultaneously may interfere with the detection process because electrons from more than one column 12 may be detected by the same detector.

According to an embodiment of the present invention, one of columns 12 or additional column may be designed for energy dispersion X ray (EDX) including high current up to 1 microAmpere for fast diffraction analysis spectroscopy of material composition. The EDX column is optionally of non-normal or of high tilt angle to enhance interaction with defects near the surface. Another embodiment includes an additional column optimized for a high resolution top view of the defect. An additional movable column might be further added in order to adjust the distance between the defect and the reference image in order to re-detect the defect in the fastest way possible as one column scans the defect and the other scans the reference defect simultaneously. Since review requires higher resolution (e.g. in the range of 2-3 nm) and lower scan rate than inspection, a magnification lens is preferably incorporated into the design which adds crossover. The beam current is typically lower than used in an inspection system so that resolution is not decreased due to Coulomb aberrations at the crossover.

Classification algorithms may be performed according to size and shape of the defect as viewed with configuration 11, preferably with additional images and information acquired by the high resolution column and the EDX column. If there is an uncertainty regarding the classification of the defects, configuration 11 with high tilt angles permits easier inspection of wafer topography or more accurate location of the defect relative to the wafer surface. For example, configuration 11 is useful to determine whether the defect is a hillock or pit. In conclusion, combining columns 12 tilted at different angles angle, typically in addition to a top view gives a powerful tool for automatic classification.

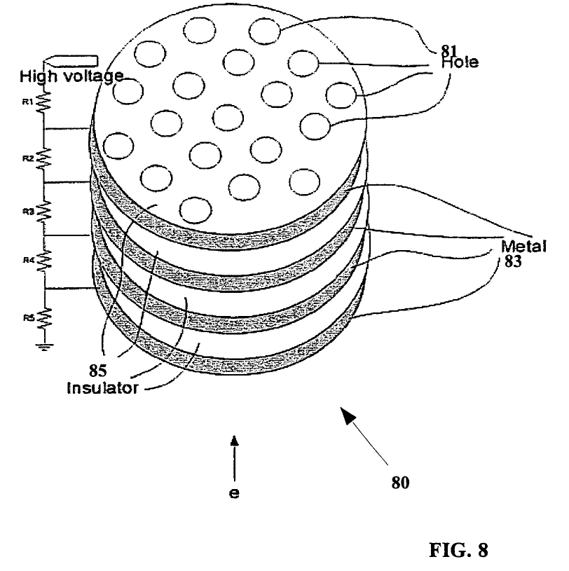

Reference is now made to FIG. 8 illustrating a layered electron multiplier (LEM) detector 80, according to an embodiment of the present invention. Electron multiplier (LEM) detector 80 is constructed from a series of, e.g. 3 to 10, thin layers one above the other, separated by insulating layers 85 or gaps 85. The thin layers are perforated by an array of holes 81 of diameter ranging between 0.1 to 1 mm. The layers are either conductive, e.g. metal layers 83 or coated by a conductive film and electrically connected to an electrical potential. The inner walls of holes 81 of each conducting layer 83 are coated with a material having secondary emission properties [for example Al₂O₃ or LiF]. This creates an array of dynodes at each thin conducting layer 83. Each dynode layer 83 is maintained at a potential [100v to 1000v] difference relative to the next layer 83 of dynodes. The holes 81 of the dynodes of each layer 83 are aligned with respect to the holes of the next dynode layer. The construction and operation parameters are optimized according to the magnetic field strength [200 to 2000 Gauss, typically 700 Gauss] and orientation. There are free parameters of the design which include: (a) the secondary emission material; (b) the voltage difference between each stage on the chain; (c) the thickness and the diameter of each of the holes; and (d) the distance between each dynode layer. There are the design constraints which include: (a) the physical dimensions, mainly the thickness; (b) the required gain; (c) the response time; (d) transit time; spread time and dark current of the LEM detector 80.

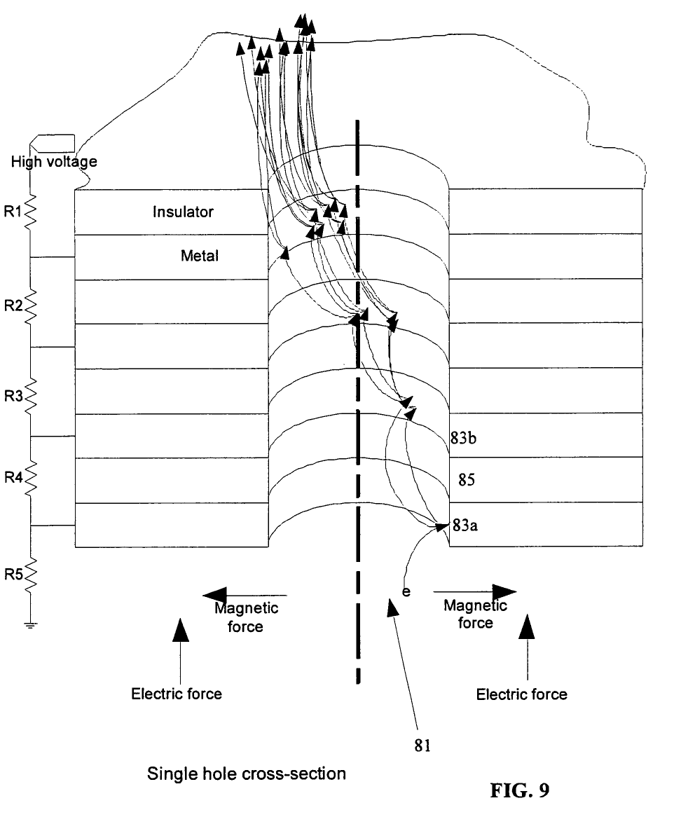

Referring now to FIG. 9, LEM detector 80 operates as follows: An electron enters LEM detector 80 hitting first dynode 83a with enough kinetic energy to extract electrons from layer wall 83a. The number of secondary electrons emitted is dependent upon the material of the dynode and is proportional to the kinetic energy of the incident particle. Since LEM detector 80 is immersed in a magnetic field, the emitted electrons start to accelerate under the influence of two forces, from the electrical field and from the magnetic field. The combination of these two forces causes the electrons to perform complex trajectories according to the electric and magnetic field directions and related to the electron initial velocity. In a prior art detector, the electrons may loss their kinetic energy while travelling from one dynode to the next or may oscillate or even return back to the surface of the dynode they ejected from. The unique layered dynodes structure, according to an embodiment of the present invention take advantage of the two forces in a constructive manner so that the electrons are accelerated efficiently from one dynode to the next dynode in the chain. The work done on an electron moving through a potential difference is given by:
W=e·ΔV (equation1),
where e is the electron charge and ΔV is the potential difference between two adjacent dynodes. This work is equal to the change in the kinetic energy of the electron. The magnetic force does not change the kinetic energy of the electron but only changes its direction, so that the combination of electric and magnetic fields applies a force on the electron which is given by:
F=e·(\vec{E}+\vec{v}×\vec{B}) (equation 2)
where v, \vec{E}, \vec{B} are the electron velocity, the electric field and the magnetic field, respectively. As F is proportional to the cross product of v and B, the magnetic force only affects the component of the velocity that is perpendicular to the magnetic field. Therefore, the force only changes the electron direction, but does not change the electron velocity. A configuration optimization of LEM detector 80 is performed using an electromagnetic simulator. Modeled electron trajectories are shown in FIG. 9. Transit time through the dynode 83 stack is less than 1 nsec. which enables a design based on LEM 80 for column data rate of 200-300 Mpixels/sec. In contrast to a micro-channel plate holes 81 are macroscopic with a typical diameter of a dynode hole is in the range of 0.5-0.8 mm. and the thickness of each layer is 0.2-0.4 mm.

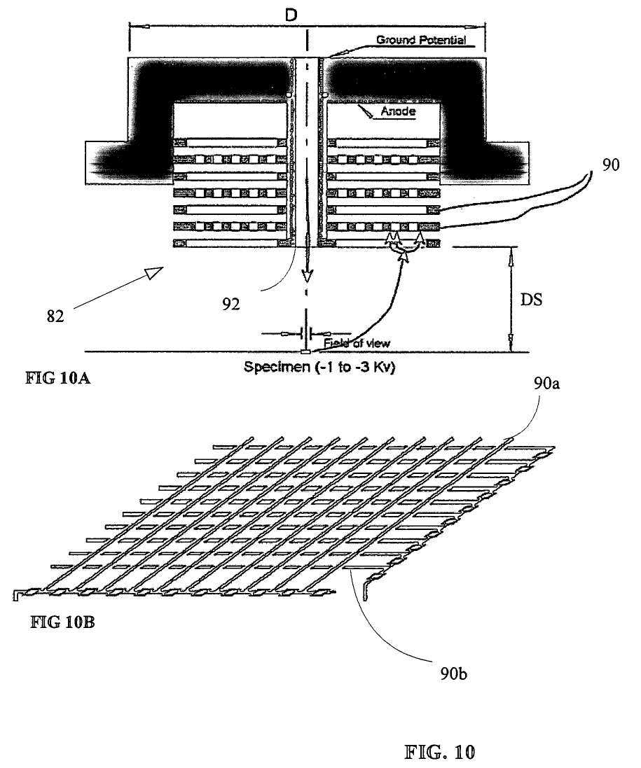

Another electron multiplier structure which is effective in the presence of strong magnetic field is a grid electron multiplier structure 82, as illustrated in FIG. 10. Grid electron multiplier 82 includes a series of grids 90 which are one or two dimensional arranged in layers lengthwise and crosswise sequentially. Grid electron multiplier 82 is constructed from an inner concentric tube 92 in which the primary electron beam 28 passes onto the specimen. Tube 92 separates primary electron beam from the detected electrons. Grid electron multiplier 82 is constructed from a series of grid layers 90 one above the other, separated by an isolating ring or space. The thin grid layers are coated with a material having secondary emission properties. This creates an array of dynodes at each thin layer. Each layer of dynodes is held at a potential relative to the next layer of dynodes. The construction and operation parameters are optimized according to the magnetic field strength and orientation. There are the free parameters of the design which include: the secondary emission material, the voltage between each dynode stage, the thickness and the width of each line or wire, the space between two lines in the grid and the distance between two consecutive dynode layers. Constraints on the design include: the physical dimensions mainly the thickness, the designed gain, the response time, transit time, spread time and dark current of the LEM.

Grid electron multiplier 82 is designed so that the back scattered electrons will be collected in the most efficient way and the electrons at the end of the multiplying cascade are input to the anode for detection.

Grid electron multiplier 82 that was designed and built of 8 mm in diameter (D). The distance DS typically of 2.5 mm between the specimen and multiplier front end is also designed for maximum collection efficiency.

System 10 was designed, built integrated and tested. The system contains 4 mini-columns 12. All four columns 12 were operational. Good spot size properties in high probe current was demonstrated. The vacuum in specimen chamber 42 is preferably 10⁻⁷ Torr and the vacuum in the gun chamber satisfactory for Schottky gun emission is preferably 3*10⁻⁹ Torr. The probe current was measured −50 nA to 1000 nA. The images were 512×512 pixels. Extracting voltage used ˜4 KV By using bias potential on specimen 22 landing energy that was used is in the range of OeV to 4 KeV. While operating two columns scanning in parallel, no detrimental effect on the resolution (or any other effect) was occurred. Resolution achieved was approximately 25 nm at 250 nanoAmpere probe current. Resolution in other conditions was demonstrated according to simulations

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

While the invention has been described with respect to a limited number of embodiments, it will be appreciated that many variations, modifications and other applications of the invention may be made.

What is claimed is:

1. A beam column including a beam of charged particles which travels substantially along an axis of the column, the beam column comprising:
(a) at least two permanent magnets having at least one magnetic dipole disposed in a plane substantially perpendicular to the axis;
(b) magnetic material located at least partially within a magnetic field of said at least two permanent magnets, wherein said magnetic material is configured to increase cylindrical symmetry of said field;
(c) at least one correction coil in proximity to an end of one of said at least two permanent magnets;
whereby said at least two permanent magnets influence a trajectory of the charge particles within said column.

2. The column, according to claim 1, wherein said at least two permanent magnets are configured to generate a non-crossover primary charged-particle beam within the column.

3. The column, according to claim 1, further comprising:
(d) a charged particle source at least partially immersed in a magnetic field of said at least two permanent magnets.

4. The column, according to claim 1, further comprising:
(d) a specimen, at least partially immersed in a magnetic field of said at least two permanent magnets.

5. The column, according to claim 1, further comprising:
(d) a detector which detects charged particles scattered from a specimen, the detector including a plurality of electrodes configured with at least one potential difference between the electrodes, wherein said electrodes include a material which exhibits emission of secondary electrons, wherein said detector is immersed at least in part by a magnetic field of said magnets, wherein at least one parameter of the detector is adjusted for maximizing signal multiplication of the electrons, by utilizing at least in part said magnetic field.

6. The column, according to claim 1, wherein said at least two permanent magnets operate as a gun lens, wherein a focal length of said gun lens is changed by independently adjusting current in said correction coil.

7. The column, according to claim 1, wherein said at least two permanent magnets operate as an objective lens, wherein a focal length of said objective lens is changed by independently adjusting current in said correction coil.

8. The column, according to claim 1, further comprising:
(d) a plurality of multi-pole charged particle beam deflecting elements which form at least two stages of a multi-pole charged particle beam deflecting assembly; wherein said charged particle beam is deflected serially by said at least two stages, so that said charged particle beam is incident on a specimen in a direction substantially parallel to the axis.

9. The column, according to claim 8, further comprising
(e) a detector which detects electrons scattered from said specimen, the detector including a plurality of electrodes configured with at least one potential difference between the electrodes, wherein said electrodes include a material which exhibits emission of secondary electrons, wherein said detector is immersed at least in part by a magnetic field wherein at least one parameter of the detector is adjusted for maximizing signal multiplication of the electrons by utilizing at least in part said magnetic field.

10. A system comprising at least one column having an axis, the at least one column including:
(i) at least one source of charged particles which form a charged particle beam which moves through the at least one column in a direction substantially parallel to the axis; and
(ii) a plurality of multi-pole charged particle beam deflecting elements which form at least two stages of a multi-pole charged particle beam deflecting assembly;
wherein said charged particle beam is deflected serially by said at least two stages, so that said charged particle beam is incident on a specimen in a direction substantially parallel to the axis.

11. The system, according to claim 10, wherein said deflecting elements include at least four said elements.

12. The system, according to claim 10, wherein said charged particle beam is deflected by an electric field produced by placing a potential difference between at least two said elements.

13. The system, according to claim 10, wherein the at least one column is a column with higher resolution.

14. The system, according to claim 10, wherein the at least one column is a moveable column.

15. The system, according to claim 10, wherein the at least one column is a column equipped with energy dispersion X ray analysis.

16. The system, according to claim 10, wherein the at least one column further includes:
(iii) at least two permanent magnets having at least one magnetic dipole disposed in a plane perpendicular to the axis.

17. The system, according to claim 16, further comprising:
(iv) at least one correction coil in proximity to an end of one of said at least two permanent magnets.

18. The system, according to claim 10, wherein the at least one column is a plurality of said columns, wherein at least two said columns are substantially parallel so that all charged particle beams impinge substantially at normal incidence on a specimen.

19. The system, according to claim 10, wherein the at least one column is at least two said columns, wherein said at least two columns are substantially tilted with respect to each other so that respective charged particle beams from said columns impinge on an overlapping region of a specimen at different incident angles.

20. The system, according to claim 19, wherein the at least one column further includes at least two permanent magnets having at least one magnetic dipole disposed in a plane perpendicular to the axis.

21. The system, according to claim 10, wherein the at least one column is a column with said axis substantially normal to a specimen and another column substantially tilted relative to said specimen.

22. The system, according to claim 16, wherein said at least two permanent magnets are configured for generating a non-crossover charged-particle beam.

23. The system, according to claim 16, wherein the at least one column further includes:
(iv) a detector which detects electrons scattered from said specimen, the detector including a plurality of electrodes configured with at least one potential difference between the electrodes, wherein said electrodes include a material which exhibits emission of secondary electrons, wherein said detector is immersed at least in part by a magnetic field wherein at least one parameter of the detector is adjusted for maximizing signal multiplication of the electrons by utilizing at least in part said magnetic field.

24. The system, according to claim 23, wherein the at least one column includes at least one correction coil in proximity to an end of one of said at least two permanent magnets.

25. In a charged-particle-optical system, wherein the system generates and deflects a charged-particle beam, the system including a detector which detects charged particles scattered from the specimen, the detector including:
(a) a plurality of electrodes configured with at least one potential difference between the electrodes, wherein said electrodes include a material which exhibits secondary electron emission which provides signal multiplication, wherein said detector is immersed at least in part by a magnetic field, wherein at least one parameter of the detector is adjusted for maximizing detection performance of the electrons, thereby utilizing at least in part said magnetic field, wherein the system generates a primary charged-particle beam substantially normally incident on the specimen.

26. The charged particle-optical system, according to claim 25, wherein said detector includes a plurality of layers, including a plurality of conducting layers interspersed with a plurality of insulating layers, each layer having an array of holes therein, said holes being substantially aligned, said holes within said conducting layers being coated with said material exhibiting secondary emission, wherein said electrodes include said conducting layers.

27. The charged particle-optical system, according to claim 26, wherein said at least one parameter is selected from the group of parameters consisting of said material having secondary emission, said at least one potential difference, at least one layer thickness, and at least one diameter of said holes.

28. The charged particle-optical system, according to claim 25, wherein said plurality of electrodes includes a plurality of parallel grids, wherein each grid includes a plurality of conducting wires, wherein said grids are coated with said material having secondary emission; at least one spacer which separates said grids; and a voltage supply configured for maintaining said at least one potential difference between said grids.

29. The charged particle-optical system, according to claim 28, wherein said at least one parameter is selected from the group of parameters consisting of said material having secondary emission, said at least one potential difference, thickness of a wire, a distance between wires, and distance between the planes.

30. A method for rapidly processing a specimen, the method comprising the steps of:
(a) generating a plurality of charged-particle beams travelling substantially along respective axes of an array of charged-particle beam columns, by providing each beam column with at least two permanent magnets having at least one magnetic dipole disposed in a plane substantially perpendicular to the axis;
(b) independently controlling trajectory and focussing said beams onto the specimen; and
(c) deflecting said beams while maintaining incidence of said beam on the specimen substantially parallel to the axis.

31. The method, according to claim 30, wherein said deflecting includes scanning by at least one of said charged particle beams, wherein said scanning is not performed simultaneously with scanning by another of said charged particle beams.

32. The method, according to claim 30, wherein said charged particle beams include non-crossover charged particle beams.

33. The method, according to claim 30, further including the step of:
(d) detecting charged particles scattered from the specimen using a detector at least partially immersed in a magnetic field, by utilizing at least in part said magnetic field.

34. The method, according to claim 33, wherein said detector includes a plurality, of electrodes configured with at least one potential difference between the electrodes, wherein said electrodes include a material which exhibits secondary electron emission which provides signal multiplication, wherein at least one parameter of the detector is adjusted for maximizing detection performance.

35. The method, according to claim 30, wherein each column a correction coil located at an end of at least one of said at least two permanent magnets; wherein said controlling and focussing is performed by adjusting current in said correction coil.

36. The method, according to claim 30, wherein said deflecting is performed in each column using a plurality of multi-pole charged particle beam deflecting elements which form a multi-stage multi-pole charged particle beam deflecting assembly.

37. A method for detecting charged particles, the method comprising the steps of:
(a) providing a plurality of electrodes wherein said electrodes include a material which exhibits emission of secondary electrons;
(b) immersing said electrodes at least in part by a magnetic field; and
(c) maximizing performance of said detecting so that at least one trajectory of said secondary electrons impinge on said electrodes by utilizing said magnetic field.

38. The method, according to claim 37, further comprising the step of:
(d) generating a charged-particle beam travelling substantially along an axis of a charged-particle beam column, by providing said beam column with at least two permanent magnets having at least one magnetic dipole disposed in a plane substantially perpendicular to said axis; wherein said magnetic field is provided at least in part by said at least two magnets.
